(19) United States
(12) Patent Application Publication
(10) Pub. No.: US 2022/0170452 A1
(43) Pub. Date: Jun. 2, 2022

(54) FLUID EJECTION APPARATUS FOR DISCREET PACKET TRANSFER OF FLUID

(71) Applicant: Hewlett-Packard Development Company, L.P., Spring, TX (US)

(72) Inventor: Robert S. Wickwire, Corvallis, OR (US)

(73) Assignee: Hewlett-Packard Development Company, L.P., Spring, TX (US)

(21) Appl. No.: 17/288,540

(22) PCT Filed: Aug. 13, 2019
(86) PCT No.: PCT/US2019/046280

§ 371 Date: Apr. 25, 2021

(51) Int. Cl. F04B 43/02; F04B 43/00; F04B 9/04; B41J 2/175

(52) U.S. Cl. CPC F04B 43/026; B41J 2/17596; F04B 9/042; F04B 43/0045

(57) ABSTRACT

Present examples provide a fluid ejection apparatus which may comprise a pump having a pump body and a plurality of diaphragms disposed in the pump body. A plurality of fluid chambers are each associated with the plurality of diaphragms. A timing mechanism may open a leading fluid chamber of the plurality of fluid chambers and close a trailing fluid chamber of the plurality of chambers simultaneously with movement of corresponding pairs of the diaphragms. A third fluid chamber may be in a dwell mode. The movement of the timing mechanism causes discreet packet transfer of fluid between the leading and trailing fluid chambers or between a fluid chamber and a coupling.

### BACKGROUND

Present examples relate to a fluid ejection apparatus for, for non-limiting example, an ink jet printer. More specifically, but without limitation, present examples relate to a progressive packet pump for a fluid ejection apparatus which moves discrete packets of fluid between chambers as the pump operates.

### BRIEF DESCRIPTION OF THE DRAWINGS

FIG. 1 is a schematic view of a fluid ejection apparatus;

FIG. 2 is an illustrative example of a pump for a fluid ejection apparatus;

FIG. 3 is an exploded perspective view of the pump of FIG. 2;

FIG. 4 is a sectioned perspective view of the example pump with one diaphragm in a first position;

FIG. 5 is a sectioned perspective view of the pump with the diaphragm in a second position differing from FIG. 4;

FIG. 6 is a bottom view of a fluid interconnect plate, which shows the fluid chambers;

FIGS. 7a-7c are schematic views of the sequencing of the fluid chambers in the fluid interconnect; and,

FIG. 8 is a sequential view of the three diaphragms in operation during a pump cycle.

### DETAILED DESCRIPTION

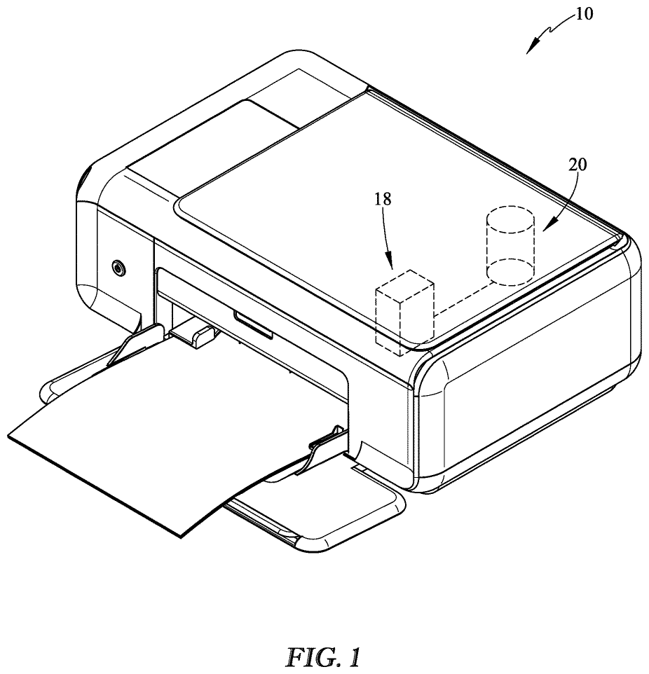

Referring now to FIGS. 1-8, examples of a progressive pump for a fluid ejection apparatus are shown throughout this teaching. The examples provide discrete fluid packet movement of the fluid through various positions within the pump between an inlet and an outlet. A fluid packet is a controlled volume of fluid which is being moved from a first position to a second position within a pump. A cam, which may be radially symmetrical, is provided which may be reversed so that the pump may operate in either of two directions. The fluid chambers within the pump are opened and closed simultaneously in pairs with one pair moving fluid at a time. The chambers in the fluid moving pair can either be fluidically connect to the fluid interconnects to move packets of fluid in and out of the pump or to each other to pass a packet of fluid between fluid chambers Other chambers outside the moving pair are closed for fluid movement, therefore the fluid transfer in, out, and within the pump is controlled and is a discrete fluid packet. Moreover, the fluidic isolation between the inlet and outlet of the pump allow for opposition to large positive and negative heads both while pumping and when the pump is stationary.

Referring now to FIG. 1, a schematic view of a fluid ejection apparatus 10 is depicted. The depicted example provides an inkjet printing apparatus, which utilizes a fluid such as, for non-limiting example, an ink. In order to print the ink to a media, a pump 20 is utilized to move ink or other fluid to a print head 18 in order to print to the media. In the depicted example, the fluid ejection apparatus 10 schematically depicts the pump 20 fluidly connected to the print head 18, which directs the ink on to a media, such as paper. While an inkjet printer is shown in the instant example, other fluid source and destination structures or mechanisms may be embodied which utilize such pump to move a fluid. Accordingly, the description of the ink jet printing apparatus is merely an example and not to be considered limiting.

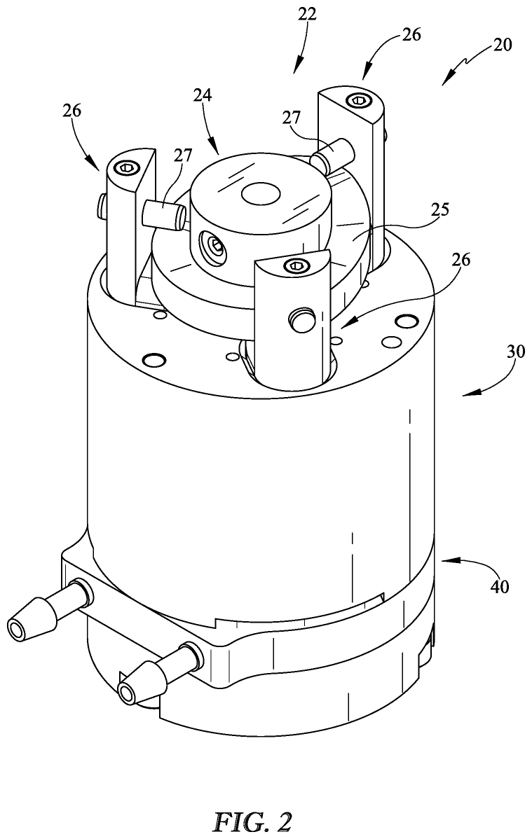

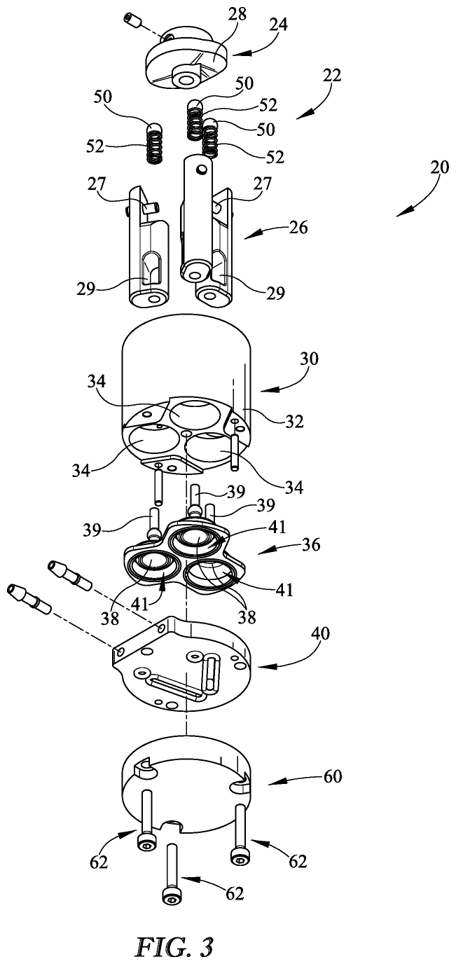

Referring now to FIG. 2, a perspective view of an example pump 20 is depicted. The pump 20 comprises a timing mechanism 22 that allows for the movement of discreet fluid packets through the pump 20. The timing mechanism 22 comprises in some examples a cam 24 and a lifter 26. These structures allow for timed movement of diaphragms 38 (FIG. 3) within the pump 20.

The cam 24 rotates to drive motion of a plurality of the lifters 26 according to some examples. For example, movement of the cam 24 may cause raising and lowering of the lifters 26. The cam 24 may be rotated by a motor, transmission, or a combination thereof. The cam 24 has an upper surface 25 which varies in elevation to change the position of the lifters 26 relative to a fluid interconnect plate 40. The cam 24 may also have a lower surface 28 which is parallel to the top surface 25 and which may also vary the position of the lifters 26 similar to the upper surface 25. For example, the upper surface 25 may pull the lifters 26 away from the fluid interconnect plate 40 and the lower surface 28 may push the lifters 26 back towards a fluid interconnect plate 40. The lifters 26 drive movement of diaphragms 38 within the pump body 30 to displace volume and movement of the discrete fluid packets within the fluid interconnect plate 40. The fluid packets are controlled amounts of fluid, for example ink. In the instant example, each fluid packet may move from one fluid chamber to a second fluid chamber, to a third fluid chamber before exiting the pump 20. The fluid packets are discreet because fluid from one chamber moves to another due to the sequenced movement of pairs of diaphragms 38 (FIG. 3) and the opening and closing of valves within the pump 20.

Referring now to FIG. 3, an exploded perspective view of the pump 20 is depicted. Starting at the top of the figure, the cam 24 and lifters 26 are shown. These structures at least partially define the timing mechanism 22. The cam 24 is generally circular with a top surface 25 and bottom surface 28 of varying elevation. This may be semi-helical or other varying elevational changes. In some examples, the top surface 25 increases the elevation of a follower 27 that engages the surface 25. The follower 27 may extend from the lifter 26. The bottom surface 28 decreases the elevation of the ball 50 and spring 52 that engages the surface 28. The ball and spring may extend from the lifter 26.

As the cam 24 rotates, the follower 27 moves up and down along the top surface 25 of the cam 24. A lower surface 28 of the cam 24 may be engaged by a ball 50 associated with each lifter 26. While the upper portion of the ball 50 engages a lower surface 28 of the cam 24, a lower portion of the ball 50 may be engaged by biasing element 52. The biasing element 52 may be formed of various structures which provide a force on the ball 50 and transmits such force to the lifter 26. In the example depicted, but without limitation, a coil spring is shown. Other structures may be used, for example, a biasing arm or element which may extend from the lifter 26 and/or may be formed integrally therewith rather than being a separate and distinct part. The ball 50 and biasing element 52 maintain a biasing force on the cam 24 so that the cam 24 remains in engagement with the follower 27. Accordingly, where prior art pumps may have highly controlled tolerances, the biasing element 52 aids to take up slack or tolerance between parts.

Also depicted in these views, are the top 25 and bottom 28 surfaces of the cam 24 which are radially symmetrical which enables the pump 20 to flow in two directions by changing the direction of rotation of the cam. In this way, the cam 24 is bi-directional allowing for bi-directional movement of the pump 20.

The lifter 26 further comprises a seat 29 which receives a stem 39 of a diaphragm 38. With movement of the lifter 26 up and down, each diaphragm stem 39 associated therewith may also move vertically up and down with the lifter 26. The lifters 26 are shown also having the followers 27 located at an upper end thereof but may be formed in various manners. While a set screw and shaft are shown, the follower 27 may also be formed integrally with the lifter 26 or may be connected in other manners.

Beneath the lifters 26 is a pump body 30. The pump body 30 may be of various shapes and according to one example, the pump body 30 may be formed with a side wall 32 and a plurality of chambers 34 within the side wall 32. The chambers 34 may be of various shapes and in some examples may be generally cylindrical in shape, as depicted, to receive either or both of the lifter 26 and the diaphragm 38. However, the shape of the chambers 34 may vary in such a manner as to receive a similarly shaped diaphragm and or the lifter 26. In some examples however, the shapes may differ and the relationship of the shape of a chamber 34 and the diaphragm 38 is not limiting.

Beneath the pump body 30 is a diaphragm plate 36 which includes a plurality of circular shaped diaphragms 38. The diaphragms 38 may be formed of various elastomeric materials. In the instant example, there are three diaphragms 38. The diaphragms 38 are elastic and may vary in shape with movement of the diaphragm stems 39. The diaphragms 38 may therefore change volume with movement. The diaphragms 38 may flex with movement of the stems 39 and lifters 26, in order to change the volume of a fluid chamber 41 formed between the fluid interconnect plate 40 and each diaphragm 38.

Beneath the fluid interconnect plate 40 is a base plate 60. The base plate 60 serves as a mounting plate for the various structures described and fasteners 62 may extend through the base plate 60 and into the pump body 30 for securing the assembly.

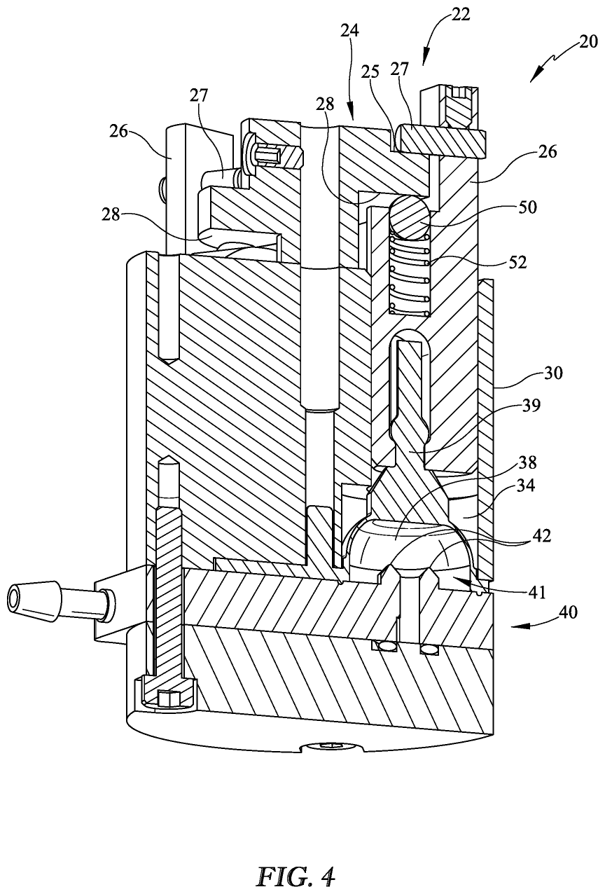

Referring now to FIG. 4, a sectioned perspective view of pump 20 is depicted. The figure reveals the operation of the timing mechanism 22, cam 24 and the subsequent movement of the diaphragm stems 39 and diaphragm 38. The timing mechanism 22 includes the cam 24 near the top of the assembly and the follower 27 on the right-hand side of the depicted example is at a high point of the cam surface 25. Moving left, a second follower 27 is shown at a slightly lower elevation than the far right-hand side follower 27. A third follower 27 may be located at a lowest elevation of the three.

In the section view, and with reference to the right-hand side of the assembly, the ball 50 is shown engaging in the under surface 28 of the cam 24 and is biased upwardly by the biasing element 52. The sectioned lifter 26 also reveals the positioning of the diaphragm 38 and the stem 39 within the chamber 34 of the pump body 30. In the depicted example, the diaphragm 38 is flexed away from the fluid interconnect plate 40 and sealing surfaces 42 thereon. The fluid chamber 41 is shown defined between the diaphragm 38 and the fluid interconnect plate 40. The lifter 26 depicted in the section view is lifted to a high point in its cycle of upward and downward movement. As a result of the upward positioning, the stem 39 is pulled upwardly and the diaphragm 38 is flexed to maximize the volume of the fluid chamber 41 formed by the diaphragm 38 and fluid interconnect plate 40. Alternatively, the other lifters 26 are in more downward positions and accordingly, those diaphragms 38 (not shown) are flexed downwardly and may be sealed against the sealing surfaces 42.

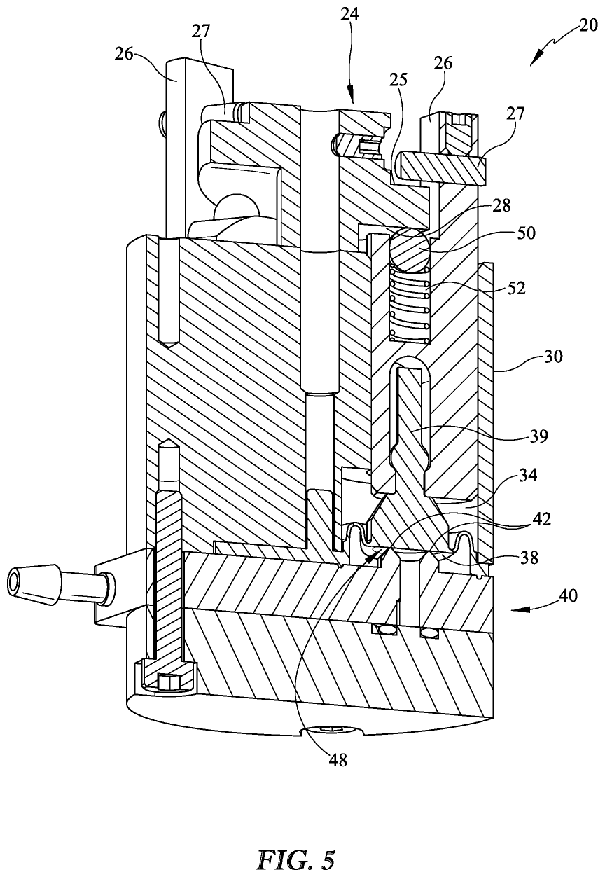

With reference now to FIG. 5, an alternate section view is depicted showing a differing position of the diaphragm 38 shown in FIG. 4. The lifter 26 is depicted in the lowest position with the top inner surface of the diaphragm 38 resting on the valve sealing surface 42. Once the lifter 26 and diaphragm 38 have reached this position the cam 24 continues to push downwardly on the ball 50 causing the lower surface 28 to force the ball 50 and biasing element 52 down adding additional force to seal the diaphragm 38 to the valve sealing surface 42 in the fluid interconnect plate 40. In this position the upper surface 25 of the cam 24 drops away from the lower surface of the follower 27 enabling compression of the diaphragm 38 onto the valve sealing surface 42.

During operation, the cam 24 is formed so that a leading diaphragm 38 opens at the same time as a trailing diaphragm 38 closes, which allows for the sequential movement of fluid. The terms leading and trailing are used from the perspective of the rotational direction of the cam and the direction of flow of the fluid. That is, leading refers to a location the fluid is filling and trailing refers to a location that the fluid is exiting. The fluid movement is described as movement discrete packets because a finite amount of fluid of one fluid chamber 41 and diaphragm 38 can move at a time. Thus, the controlled movement of the fluid occurs in a sequential nature.

With reference to both FIGS. 4 and 5, and to summarize, maximum volume is achieved by pulling the stem 39 away from the fluid interconnect plate 40 which un-rolls and straightens the sides of the cup and moves the roof of the diaphragm 38 further away from the fluid interconnect plate 40. Alternatively, volume in the fluid chamber 41 is reduced by moving the stem 39 of the diaphragm 38 towards the fluid interconnect plate 40. This causes the sides of the diaphragm 38 to roll over and the inner roof of the diaphragm to move closer to the fluid interconnect plate 40 reducing the volume that can be contained within.

The timing mechanism 22 in the instant examples may comprise of the timing cam 24, the diaphragm lifters 26, and valve biasing element 52. As mentioned, the top surface 25 of the cam 24 pulls the diaphragm lifters 26 towards the cam 24 which pulls the diaphragms 38 open to maximum volume. The bottom surface 28 of the cam 24 pushes the lifters 26 away from the cam 24 minimizing the volume in the diaphragm 38. As mentioned above the bottom 28 of the cam 24 causes the diaphragm lifter 26 to overtravel beyond the point that the diaphragm 38 contacts the sealing surface 42 compressing the biasing element 52 and providing the closing force to make an effective seal.

Timing of motion and fluid flow is also controlled by the cam 24. In the example describe herein, since there are three chambers 34 the cam 24 is divided into 3 equal 120° sections. One section is the lowest cam dwell position that holds a diaphragm lifter 26 in the minimum-volume, valve closed position for the entire 120°. The next two 120° sections form ramps that start at the dwell surface and rise symmetrically to a common high cam, diaphragm open point. This symmetrical set of ramps causes a set of two chambers to change volume simultaneously with the leading chamber in the set increasing in volume (opening) to accept fluid from the trailing chamber which decreases in volume (closes). The trailing chamber is left in the minimum volume, valve closed position and the chamber pairing advances, so the current leading chamber becomes the trailing chamber in the next chamber pairing. This advancing chamber pairing sequences through all sets of chambers in the pump head before starting the sequence over.

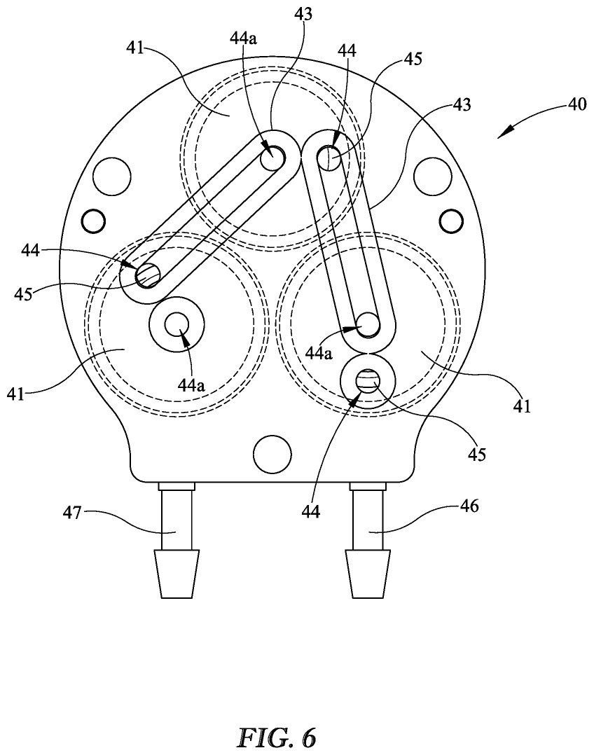

With reference now to FIG. 6, a bottom view of the fluid interconnect plate 40 is depicted. In this view, the fluid interconnect plate 40 is shown having three fluid chambers 41, each corresponding to one of the diaphragms 38 of the diaphragm plate 36 (FIG. 2). Extending though the fluid interconnect plate 40 are two fluid passages 44, and 44a per fluid chamber 41 that direct fluid in and out of each fluid chamber 41. Passages 44a are located at the center of each fluid chamber 41 so that flow can be interrupted by the isolation valve formed by diaphragm 38 and valve sealing surface 42. Passages 44 direct fluid to each chamber outside of the isolation valve, so flow is unrestricted through this passage. The fluid interconnect plate 40 also comprises first and second couplings 46, 47 which are used to connect the pump to a source and destination for fluid being conveyed. The fluid interconnect plate 40 also comprises lateral passages 43 which direct the movement of fluid through the chambers of the pump in a daisy-chain fashion. For example, the lateral passages direct fluid from one coupling 46, 47 into the first chamber, out the first fluid chamber 41 into the second fluid chamber 41, out the second fluid chamber 41 and into the third fluid chamber 41, and out the third chamber to the second coupling 46, 47. In this example the lateral passages 43 are formed from, but not limited to, elongated O-rings. In addition, in this example the lateral passages 43 connect the non-valved passages 44 of one fluid chamber 41 to valved passages 44a in the next fluid chamber 41, however the lateral passages 43 can connect the passages of leading and following fluid chambers 41 in any order. One of the two couplings 46, 47 may be an inlet and the other may be an outlet of the pump 20. In a similar fashion passages 44 and 44a may be an inlet and the other an outlet of each fluid chamber 41. These are non-limiting because the pump may work in bi-directional manner. That is, either of the two couplings 46, 47 may be an inlet and either of the two may be an outlet, depending on the direction of the rotation of the cam 24.

In each fluid chamber 41 there may be an isolation valve 48 (FIG. 5), which may be formed by the diaphragm 38 and the sealing surface 42, leading to the next fluid chamber 41 in the series that closes when the diaphragm 38 is in the lowest volume position. The valve may comprise of the inner flat roof surface of the diaphragm 38 that mates and seals to the thin edge of the valve sealing surface 42 detail surrounding the center hole 44a in the fluid interconnect plate 40 for each fluid chamber 41. The valve closing force is supplied by the biasing element 52 that is compressed by the bottom surface 28 of the timing cam 24 when its over-travels towards the fluid interconnect plate 40. The travel is beyond the point where the diaphragm 38 touches the surface of the valve sealing surface 42. The over-travel drives the diaphragm 38 onto the valve sealing surface 42 with a controlled force. As the cam 24 continues to turn past the downward dwell period, the top surface 25 of the cam 24 re-engages the follower 27 of the lifter 26 and lifting the diaphragm 38 and opening the isolation valve 48 (FIG. 5) allowing fluid to flow into the chamber 41. When an isolation valve 48 is fully open there is a large space between diaphragm 38 and valve sealing surface 42 that is in the flow of fluid in and out of the chamber 41 which provides a self-cleaning function to the valve seat. There may be at least one or two isolation valves 48 closed throughout the pump cycle which automatically isolates the pump inlet 46 and outlet 47 regardless whether the pump 20 is running or is stopped. This simplifies the design in that an encoder is not needed on the pump or pump drive to ensure that the pump is stopped in a position where the isolation valves are closed.

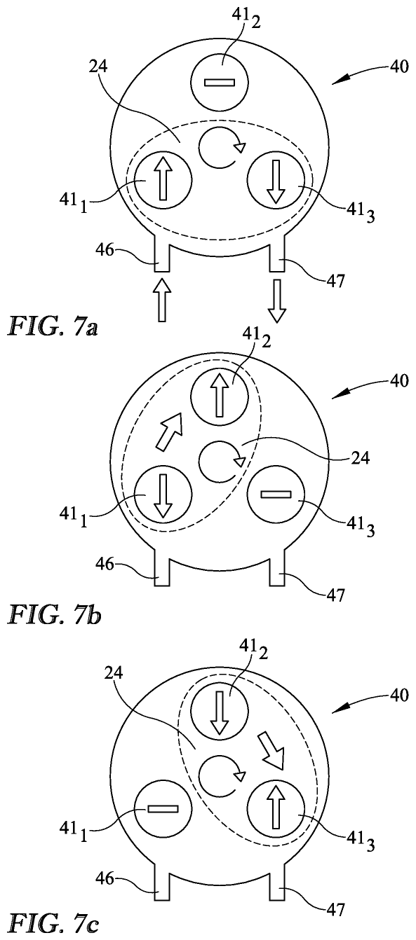

Referring now to FIGS. 7a-7c, three sequence schematic views are shown to provide teaching of the sequencing of the fluid chambers 41 of the fluid interconnect plate 40 and the movement of packets of fluid through the pump 20. Each of the fluid chambers 41 is provided a subscript for purpose of clarification of description. In each sequence segment view, one pair of fluid chambers 41 is circled with a broken line to indicate the pair of chambers 41 that are changing volume at that moment in the sequence. In addition, the pair of encircled chambers 41 contain up-down arrows to indicate which of the pair of chamber volumes is increasing (up arrow) and which is decreasing (down arrow). Further the third chamber 41 outside of the broken line has a horizontal bar which indicates that it is not changing but is in dwell. As previously described, when a chamber 41 is in dwell, the isolation valve 48 (FIG. 5) associated with that chamber, is closed so no fluid can pass through that chamber 41. Also, the semi-circular arrow represents the rotational direction in this example of the cam 24. With reference first to FIG. 7a, the sequence shows what occurs during a first segment of the rotation of the cam 24. In FIG. 7a, the inlet 46 is shown with the arrow going into the fluid interconnect plate 40 and the outlet 47 is shown with the arrow going outwardly therefrom. In the figure, the first fluid chamber 41₁ and third fluid chamber 41₃ are circled indicating that the internal volume of these two chambers 41 are changing. As previously described, one pair of fluid chambers 41 are transferring fluid at one time with the leading chamber increasing in volume and the trailing chamber simultaneously decreasing in volume. In FIG. 7a the isolation valve 48 in fluid chamber 41₂ is closed preventing fluid from moving between fluid chambers 41₁ and 41₃. This causes a packet of fluid to be drawn in from pump inlet 46 into fluid chamber 41₁ and a separate packet of fluid to be expelled out of outlet 47 from fluid chamber 41₃. In this starting segment of the pump cycle none of the fluid chambers 41 are fluidically connected to another but rather the first and last chambers are fluidically connected to the fluid supply and destination couplings 46, 47.

With reference to FIG. 7b, the second segment of the pump cycle, the leading fluid chamber 41₁ is reducing in volume while the following fluid chamber 41₂ is simultaneously increasing in volume causing a packet of fluid to be transferred from fluid chamber 41₁ into fluid chamber 41₂. At the same time the isolation valve 48 in fluid chamber 41₃ is closed to prevent fluid from being sucked back into fluid chamber 41₂ from outlet 47 which would greatly decrease the efficiency of the pump.

With reference now to FIG. 7c, the third and final segment of the pump cycle, the leading fluid chamber 41₂ is reducing in volume while the following fluid chamber 41₃ is simultaneously increasing in volume causing a packet of fluid to be transferred from fluid chamber 41₂ into fluid chamber 41₃. At the same time the isolation valve 48 in fluid chamber 41₁ is closed to prevent fluid from being sucked into fluid chamber 41₁ from inlet 46 which would greatly decrease the efficiency of the pump. Thus, from these sequences, it is clear that two fluid chambers 41 are transferring fluid at any one time with the leading fluid chamber increasing in volume and the trailing fluid chamber decreasing in volume to move packets of fluid in and out of the pump and between fluid chambers 41.

As has been described briefly and is more clearly shown in FIG. 7, the fluid chambers 41 may be isolated in desired manners during operation so that discreet fluid packets are moved from one chamber to another. The valves that control movement of packets of fluid in, out, and around the pump act as isolation valves 48 that fluidically disconnect the inlet from the outlet side of the pump. Regardless of rotational degree, or position, the cam 24 is disposed least one and sometimes two of the isolation valves 48 are in a closed position whether the pump is running or is stopped.

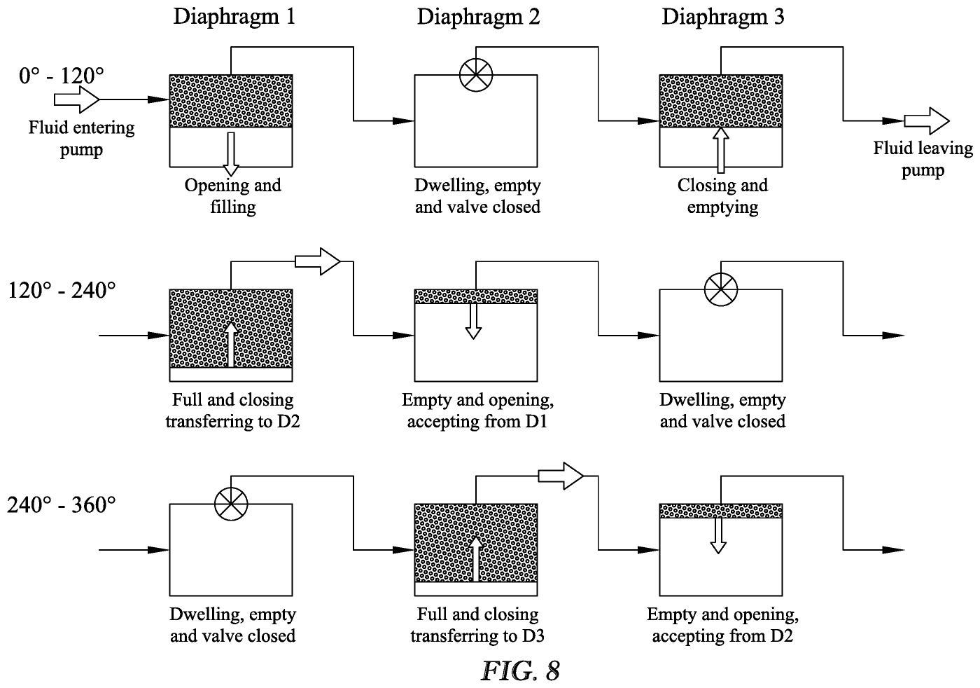

Referring now to FIG. 8, a schematic sequence of the three diaphragms 1, 2, 3 are shown in relation to the cam 24 (FIG. 24) rotation positions. The three diaphragms also correspond to the fluid chambers 41 having subscript numbers in FIGS. 7a-7c. Each column represents one of the diaphragms 1, 2, 3 and the rows represent the general position of the cam 24 during a rotation. In the 0-120 degree cam rotation, diaphragm 1 is opening and filling the fluid chamber defined by one or both of the diaphragms 38 (FIG. 4) and the corresponding fluid chamber 41 (FIG. 4) of the fluid interconnect plate 40 (FIG. 4). At the same time, diaphragm 2 is in a dwell state wherein the valve connecting the diaphragm 2 to diaphragm 3 is closed. Further, at this time in rotational position of the cam 24, diaphragm 3 is closing and emptying.

Moving one column down to the cam positioning of 120-240 degrees, diaphragm 1 is full and closing for transfer of fluid to diaphragm 2, which is open and accepting fluid from diaphragm 1 from a fluid flow path extending therebetween. Diaphragm 3 is in a dwell state.

Referring now to diaphragm 3, with the cam position between 240-360 degrees, diaphragm 1 is in a dwell state and closed to fluid communication. Diaphragm 2 is full and closing; and diaphragm 3 is opening to receive fluid from diaphragm 2 via a fluid flow path therebetween.

As will be understood with this disclosure, various improved functionalities. The isolation valves 48 allow for movement of discreet packets of fluid through the pump from the inlet 46, through fluid chambers 41, and to the outlet 47. The timing mechanism 22 and the isolation valves 48 allow for isolation of pairs of the fluid chambers 41 regardless of the position of the cam 24. With this isolation, the pump 20 can withstand large positive or negative head pressures and reduce differential metering, for example when a fluid circuit has differing pressure and volume characteristics on either side of the pump. The pump 20 may also comprise a reversible or bi-directional operation. The pump 20 may be reversed by changing direction of the cam 24.

The pump 20 may also provide self-priming functionality. That may be with fluid, air or a combination of fluid and air.

While the foregoing is directed to the various examples described, other and further examples may be devised without departing from the basic scope of the claims that follow. For example, the present examples contemplate that any of the features shown in any of the examples described herein, or incorporated by reference herein, may be incorporated with any of the features shown in any of the other examples described herein, or incorporated by reference herein, and still fall within the scope of the present claims.

1. A fluid ejection apparatus, comprising:
a pump having a pump body and a plurality of diaphragms disposed in the pump body;
a plurality of fluid chambers which are each associated with the plurality of diaphragms; and
a timing mechanism which is to open a leading fluid chamber of the plurality of fluid chambers and to close a trailing fluid chamber of the plurality of chambers simultaneously with movement of corresponding pairs of the diaphragms, and a third fluid chamber is to be in a dwell mode;
wherein movement of the timing mechanism is to cause discreet packet transfer of fluid between the leading and trailing fluid chambers or between a fluid chamber and a coupling.

2. The fluid ejection apparatus of claim 1, further comprising a fluid flow path between pairs of the plurality of chambers.

3. The fluid ejection apparatus of claim 2, wherein the leading fluid chamber receives the fluid via the fluid flow path and the trailing fluid chamber expels the fluid.

4. The fluid ejection apparatus of claim 1 wherein the plurality of fluid chambers is three or more fluid chambers.

5. The fluid ejection apparatus of claim 1, wherein the timing mechanism comprising a cam and a lifter which is to engage the cam.

6. The fluid ejection apparatus of claim 5, further comprising a diaphragm which is to vary a volume of a fluid chamber by engagement with the lifter.

7. The fluid ejection apparatus of claim 6 wherein pairs of fluid chambers are in fluid communication.

8. The fluid ejection apparatus of claim 6, further comprising a spring to bias the diaphragm and fluidically isolate inlet and outlet sides of the pump.

9. The fluid ejection apparatus of claim 5, the plurality of lifters each having a follower that engages the cam causing raising and lowering of the lifters.

10. The fluid ejection apparatus of claim 5, the cam being reversible to operate in two directions.

11. A fluid ejection apparatus, comprising:
a pump body having a plurality of chambers;
a plurality of diaphragms, each of the plurality of diaphragms associated with one of the chambers;
a reversible cam which is to drive movement of a plurality of lifters, each of the lifters associated with one of the plurality of diaphragms; and
wherein movement of the cam is to open a leading fluid chamber and to close a trailing fluid chamber simultaneously and fluidically isolate a pump inlet and a pump outlet;
further wherein the opening of the leading fluid chamber and the closing of a trailing fluid chamber is to cause discreet packet transfer of fluid between the leading fluid chamber and the trailing fluid chamber.

12. The fluid ejection apparatus of claim 11, wherein each of the plurality of lifters is to be biased by a bias element.

13. The fluid ejection apparatus of claim 11 further comprising a fluid interconnect in fluid communication with the pump body.

14. A fluid ejection apparatus, comprising:
a fluid interconnect having a first fluid coupling and a second fluid coupling;
a pump body having a first chamber, a second chamber, and a third chamber;
a fluid interconnect in fluid communication with a first diaphragm, a second diaphragm, and a third diaphragm corresponding to and aligned with the chambers of the pump body, the fluid interconnect and each of the diaphragms defining a fluid chamber;
an isolation valve associated with each of the fluid chambers; and,
a cam which is to move the diaphragms and in turn is to move discreet packets of fluid between fluid chambers.

15. The fluid ejection apparatus of claim 14 further comprising a ball disposed against a biasing element on one side and against the cam on a second side.
